(19) United States
(12) Patent Application Publication
(10) Pub. No.: US 2021/0182406 A1
(43) Pub. Date: Jun. 17, 2021

(54) UNCENSORED TALK BACKS

(71) Applicant: ISRAEL ELHADAD, Salford (GB)

(72) Inventor: ISRAEL ELHADAD, Salford (GB)

(21) Appl. No.: 17/056,774

(22) PCT Filed: Jun. 24, 2019
(86) PCT No.: PCT/IL2019/050704

§ 371 Date: Nov. 19, 2020

Related U.S. Application Data
(60) Provisional application No. 62/689,253, filed on Jun. 25, 2018.

(51) Int. Cl. G06F 21/60; G06F 16/958; G06F 16/906

(52) U.S. Cl. CPC G06F 21/60; G06F 16/906; G06F 16/972

(57) ABSTRACT

It is disclosed a method for content items collected by a computerized server using a central database. The method includes receiving censored content items from certain sources, and making censored content available to interested parties. The certain sources include content providers applying censoring procedures, content authors or responders, and a responder application identifying a submitted content item as not published by a destined content provider applying censorship. The method includes advertising alternative site espousing censored viewpoints, advertising sites executing censorship, offering user targeted content to voluntary participants, and categorizing data relating to censored content. The method further includes producing and providing data on censoring sites or agents, producing and providing data on reasons for censoring content items, producing and providing data on viewpoints espoused by censored content, and producing and providing quantitative and qualitative measures of censored content. The method further includes interacting with a responder application regarding content items provided by the responder to a content provider applying censorship, and interacting with a reader application regarding censored content items.

### CROSS REFERENCE

The application claims the priority rights of U.S. provisional application No. 62/689,253 entitled “Uncensored Talk Backs” filed 25 Jun. 2018.

### BACKGROUND OF THE INVENTION

### Field of the Invention

The invention is in the field of Internet, dealing with websites having censorship policy and with the refused content, like censored talkbacks.

### Background

Freedom of expression is an essential part of a democratic society. Since the advent of Democracy philosophers and human rights activists have sought to find ways to protect freedom of expression from Government censorship.

Today, the freedom of expression faces a new threat, censorship by social norms. Ideas that challenge accepted or acceptable norms are not published or even censored. The “unacceptable” speech may be labeled as “hate speech” or “insulting” or “abusive” which are liable to be censored. Unfortunately, these definitions sometimes reflect social norms and are not objectively definable. The result may be closing our ears and minds to challenging ideas. Another danger of censorship is losing our awareness to growing ideologies.

Censorship may be conducted by large entities (sometimes far larger than national governments) that control the Internet or the media. Censorship may be intended to “protect the public” or it may be intended to protect the commercial and financial status of the publisher, who can be hurt by lawsuits or boycotts.

One objective of the present disclosure is to take care of the censored content and the data accompanying the censoring process and make it available to certain players in the public creation scene like interested readers, experts, journalists and authors of the censored material.

### BRIEF SUMMARY OF THE INVENTION

It is disclosed a method for content items collected by a computerized server using a central database. The method includes receiving censored content items from certain sources, and making censored content available to interested parties. The certain sources include content providers applying censoring procedures, content authors or responders, and a responder application identifying a submitted content item as not published by a destined content provider applying censorship. The method includes advertising alternative site espousing censored viewpoints, advertising sites executing censorship policy, offering user targeted content to voluntary participants, and categorizing data relating to censored content.

In some embodiments, the method further includes producing and providing data on censoring sites or agents, producing and providing data on reasons for censoring content items, producing and providing data on viewpoints espoused by censored content, and producing and providing quantitative and qualitative measures of censored content.

In some embodiments, the method further includes interacting with a responder application regarding content items provided by the responder to a content provider applying censorship. The responder application executes collecting submitted content items, popping up solicit content, tracking publication of submitted content items, sending censored content item to the central database, and sending censored content items to an alternative site.

In some embodiments, the method further includes the step of interacting with a reader application regarding censored content items. The reader application executes identifying a viewed site as a censored one, informing facts about censorship policy of a content provider, directing the reader using the reader application to alternative sites providing censored content, and providing censored content.

It is disclosed a computerized server for collecting and publishing censored content items and data on censored content. The server includes a central database for managing censored content, a categorization unit for analysis of censored content and associated agents, a censor database, and a responder database.

In some embodiments, the computerized server interacts with a content provider applying censorship policy and with alternative sites publishing censored content.

In some embodiments, the computerized server interacts with a reader application regarding censored content items.

In some embodiments, the server interacts with a responder application regarding censored content items which the responder submits to a content provider applying censorship.

### BRIEF DESCRIPTION OF THE DRAWINGS

The subject matter regarded as the invention is particularly pointed out and distinctly claimed in the concluding portion of the specification. The invention, however, both as to system organization and method of operation, together with features and advantages thereof, may best be understood by reference to the following detailed description when read with the accompanied drawings in which:

FIG. 1 depicts a system for collecting and providing censored content and its analysis in accordance with an embodiment of the current disclosure.

FIG. 2 is a flow chart of a method for collecting censored content items.

FIG. 3 is a flow chart for a method of a responder application.

FIG. 4 is a flow chart of a method of a reader application.

FIG. 5 is a flow chart of a method of accessing censored content.

### DETAILED DESCRIPTION OF THE INVENTION

The present invention will now be described in terms of specific example embodiments. It is to be understood that the invention is not limited to the example embodiments disclosed. It should also be understood that not every feature of the methods and systems handling the described game is necessary to implement the invention as claimed in any particular one of the appended claims. Various elements and features of devices are described to fully enable the invention. It should also be understood that throughout this disclosure, where a method is shown or described, the steps of the method may be performed in any order or simultaneously, unless it is clear from the context that one step depends on another being performed first.

Before explaining several embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

Before presenting certain embodiments of the present disclosure, a more general description of the invention is outlined. The current invention relates to a system to elicit content that is being censored. A system may offer people writing content an opportunity to have their content published without the standard censorship. For example, an application may be made available that collects submitted talkbacks and publishes them on an alternative site. Thus, if a given site refuses to publish a talkback the author may have recourse to express his opinion. The material may be elicited using advertising. For example, the system may buy ad space on controversial news platforms and/or highly censored sites and/or in articles relating to highly sensitive issues wherein censorship is common. The app may offer the reader the opportunity to send his reaction to the site and/or copies of talkbacks that he sends to the site. Also, advertising may be taken out on sites that express alternative opinions. These alternative uncensored sites may advertise that people might submit material that is not being published on censored sites to them. For example, a reader whose content was rejected by a talkback page of a news site may send the content to the alternative uncensored site for publication.

A user application may be offered to users who are afraid that their content is being censored. For example, the application may detect when a user is submitting a talkback and/or another content item, and automatically sends that content item to an alternative publication site. There may be one alternative site for all talkbacks and/or talkbacks may be sent to targeted sites. For example, the user may choose to have his content sent to sites of his choosing. For example, he may have his content sent to sites that he believes to be more inclusive and/or more willing to publish unpopular material. Alternatively, or additionally, he may choose to have the content sent to sites which he feels are more sympathetic to his point of view. Publishing at the alternative site may be in place of and/or along with the submission to the original site.

The application may monitor for publication of the user's submission. It may not send content that is published by the original site to an alternative site. This may be necessary to keep to publication agreements wherein the original or preferred site may stipulate that it does not accept content that is not original e.g. has been submitted to other sites.

In some embodiments, the uncensored site may be developed in cooperation with other media sites to offer a more objective talkback medium. For example, a news media may contract out its talk back page to one or more third party sites. The third-party site may offer more objective and/or more inclusive publication than the source of the article. Alternatively, if the alternative sites do not offer a more objective viewpoint, at least the possibility of different talkback publishers may encourage a more diversity than is available without the alternative sites.

In some embodiments, a mirror site may mirror content of other sites, but also include alternative content, reactions, and/or rebuttals that the original site refuses to publish.

In some embodiments, a server provides a user the ability to access content according to categories. For example, user may want to access content on a particular issue that espouses a viewpoint considered “offensive” to people holding a more mainstream opinion. The server enables the user to sift out material he wants from other material. For example, the user may stipulate that he does not want to see material that was censored because it espouses violence and/or uses language not conducive to increasing understanding and/or that wanders to issues not pertinent to the source. For example, a user may want to see material that brings factual arguments even if it presents a viewpoint labeled offensive.

A possible aspect the current invention is a system to raise awareness of censorship. Some censored content will not be published, but at least facts about what is being censored will be published, for example: how much was censored and/or why; what are the unifying themes of the censored material and/or what consistent reasoning prevents publication; what are the particular viewpoints that are being censored; is one group of people more likely to get censored than another; and/or is there material that is being censored in one context and/or when used to argue one issue, but not censored in another context or when used for arguing another issue. In some embodiments, the server provides summary statistics and/or data about what is not being published.

In some embodiments, the server may employ Artificial Intelligence methods like Neural Networks, Machine Learning and Deep learning to facilitates its missions.

A detailed description of certain embodiments is outlined below as non-limiting examples.

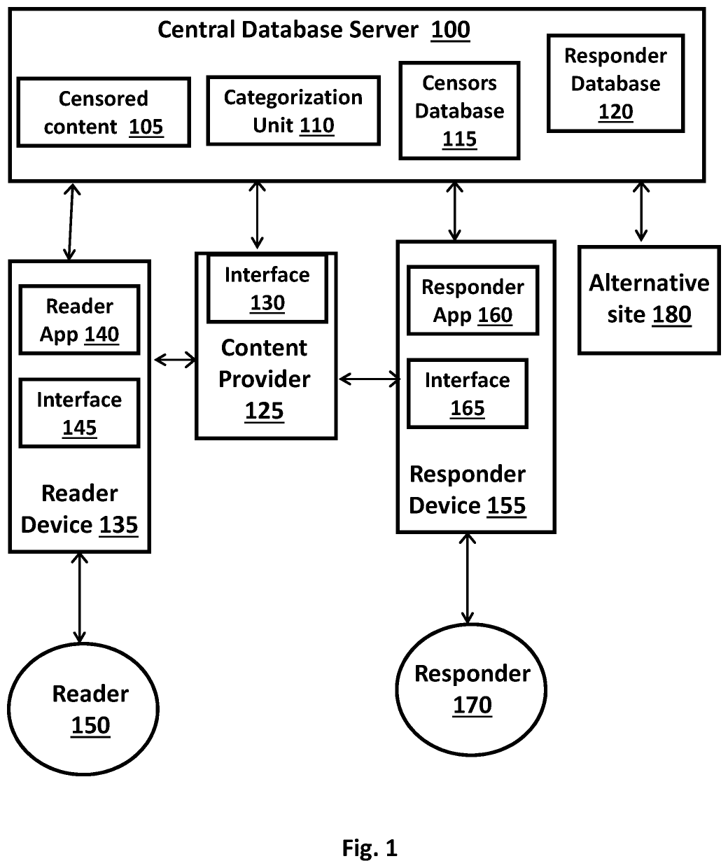

### A Server Embodiment (FIG. 1)

FIG. 1 depicts a computerized server 100 for collecting and publishing censored content items and data on censored content. The server 100 includes a central database 105 for managing censored content, a categorization unit 110 for analysis of censored content and associated agents, a censor database 115, and a responder database 120. The server 100 may further interact with a content provider 125 applying censorship policy via interface 130. Also, the computerized server 100 interacts with a reader device 135 regarding censored content items using reader application 140 and interface 145. The reader application 140 executes the actions of identifying a viewed site 125 as a censored one, informing facts about censorship policy of a content provider, directing the reader 150 to provide the censored content items to alternative sites 180, and providing censored content to other interested parties.

In addition, the server 100 may interact with a responder application 160 regarding censored content items which the responder 170 submits to a content provider 125 which applies censorship. The responder application 160 is installed in a computerized device 155, and executes the steps of collecting submitted content items, popping up solicit content, tracking publication of submitted content items, sending censored content item to the central database, and sending censored content items to an alternative site. The responder device 155 has also an interface 165 for interacting with the server 100 and with the content provider 125.

Also, the server 100 may interact with alternative site 180 which is ready to receive and content items censored out by content provider 125 and provide to readers 150.

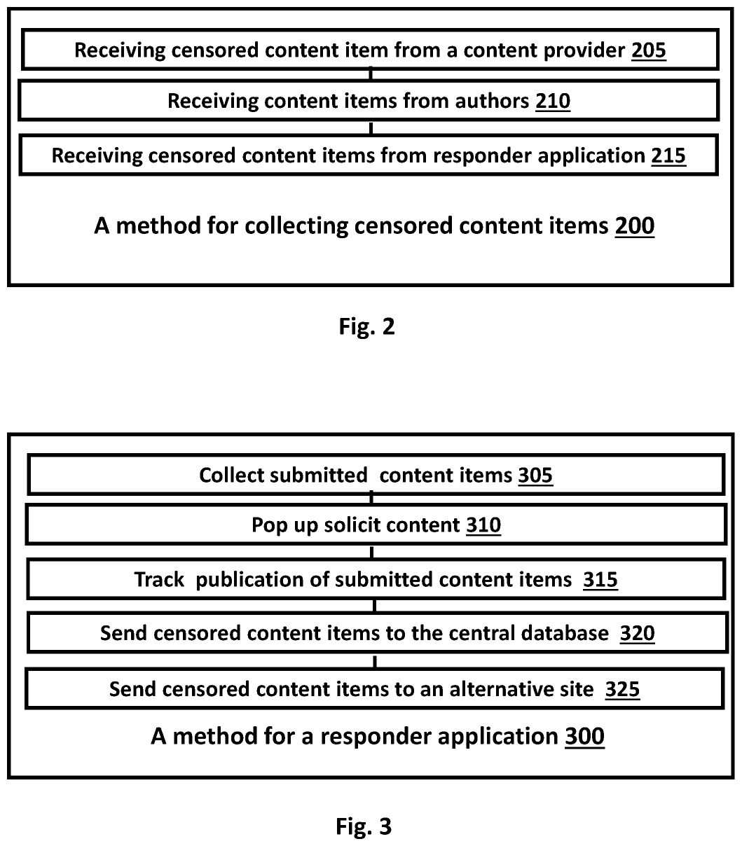

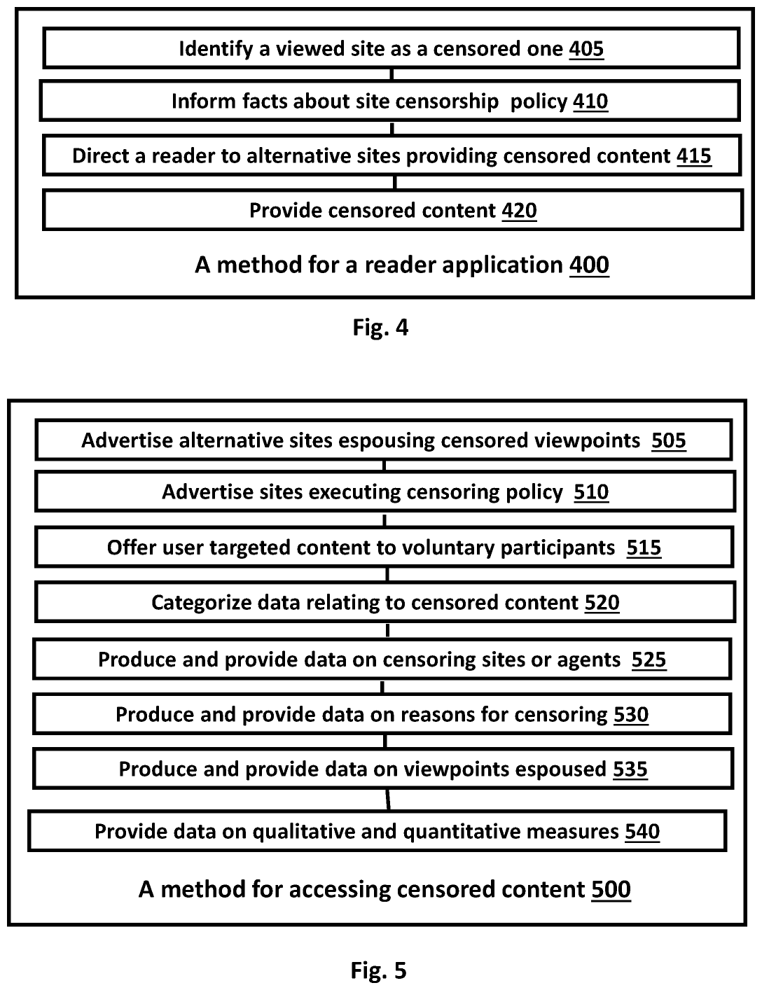

### A Server Method Embodiment (FIG. 2, FIG. 3, FIG. 4, and FIG. 5)

It is disclosed a method for manipulating content items by a computerized server 100 using a central censored content database 105. The method includes the step 200 of collecting censored content items and the step 500 of making censored content available to interested parties. The step or method 200, shown in FIG. 2, includes the step 205 of receiving censored content items from content providers 125 applying censoring procedures, the step 210 of receiving content items directly from content authors or responders, and the step 215 of receiving censored content items from a responder application 160 identifying a submitted content item as not published by a destined content provider 125 applying censorship.

To this aim, the method 200 further includes the step 215 of interacting with a responder application 160 regarding content items provided by the responder to a content provider which applies censorship. As shown in FIG. 3, the responder application 160 executes the step 305 of collecting submitted content items, the step 310 of popping up solicit content, the step of 315 of tracking publication of submitted content items, the step 320 of sending censored content item to the central database, and the step 325 of sending censored content items to an alternative site 180.

The step or method 500, depicted in the flow chart of FIG. 5, includes the step 505 of advertising alternative site espousing censored viewpoints, the step 510 of advertising sites executing censorship policy, the step 515 of offering user targeted content to voluntary participants, and the step 520 of categorizing data relating to censored content.

The method 500 may further include the step 525 of producing and providing data on censoring sites or agents, the step 530 of producing and providing data on reasons for censoring content items, the step 535 of producing and providing data on viewpoints espoused by censored content, and the step 540 of producing and providing quantitative and qualitative measures of censored content. To this aim, the method 500 further includes the step of interacting with a reader application 140 regarding censored content items. As shown in FIG. 4, the reader application 140 executes the step 405 of identifying a viewed site 125 as a censored one, the step 410 of informing facts about censorship policy of a content provider, the step 415 of directing the reader using the reader application to alternative sites providing censored content, and the step 420 of providing censored content.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. In particular, the present invention is not limited in any way by the described examples.

1. A method for content items collected by a computerized server using a central database, comprising:
a. receiving censored content items from one or more sources; and
b. making censored content available to interested parties.

2. The method of claim 1 wherein the one or more sources include:
I. one or more content providers applying censoring procedures;
II. one or more content authors; and
III. a responder application identifying a submitted content item as not published by a destined content provider applying censorship.

3. The method of claim 1 wherein the method further includes one or more steps of a list of steps which consists of:
IV. advertising alternative site espousing censored viewpoints;
V. advertising sites executing censorship policy;
VI. offering user targeted content to voluntary participants; and
VII. categorizing data relating to censored content.

4. The method of claim 1 wherein the method further includes one or more steps of a list of steps which consists of:
VIII. producing and providing data on censoring sites or agents;
IX. producing and providing data on reasons for censoring content items;
X. producing and providing data on viewpoints espoused by censored content; and
XI. producing and providing quantitative and qualitative measures of censored content.

5. The method of claim 1 wherein the method further comprises interacting with a responder application regarding content items provided by the responder to a content provider applying censorship.

6. The method of claim 5 wherein said responder application executes at list one of the steps of a list of steps which consists of:
A. collecting submitted content items;
B. popping up solicit content;
C. tracking publication of submitted content items;
D. sending censored content item to said central database; and
E. sending censored content items to an alternative site.

7. The method of claim 1 wherein the method further comprises interacting with a reader application regarding censored content items.

8. The method of claim 7 wherein said reader application executes at least one step of a list of steps which consists of:
A. identifying a viewed site as a censored one;
B. informing facts about censorship policy of a content provider;
C. directing the reader using the reader application to alternative sites providing censored content; and
D. providing censored content.

9. A computerized server for collecting and publishing censored content items and data on censored content, the server comprising:
a. a central database managing censored content; and
b. a categorization unit for analysis of censored content and associated agents.

10. The computerized server of claim 9, wherein the server further includes:
c. a censor database; and
d. a responder database.

11. The computerized server of claim 9, wherein the server interacts with a content provider applying censorship policy.

12. The computerized server of claim 9, wherein the server interacts with a reader application regarding censored content items.

13. The computerized server of claim 12 wherein said reader application is installed in a computerized device for executing at list one action of the list of actions which consists of:
E. identifying a viewed site as a censored one;
F. informing facts about censorship policy of a content provider;
G. directing the reader using the reader application to alternative sites providing censored content; and
H. providing censored content.

14. The computerized server of claim 9, wherein the server interacts with a responder application regarding censored content items which the responder submits to a content provider applying censorship.

15. The computerized server of claim 12 wherein said responder application is installed in a computerized device for executing at list one action of the list of actions which consists of:
A. collecting submitted content items;
B. popping up solicit content;
C. tracking publication of submitted content items;
D. sending censored content item to said central database; and
E. sending censored content items to an alternative site.

16. A responder application installed in a computerized device for manipulating content items provided by the responder to a content provider applying censorship.

17. The responder application of claim 16 wherein the application collects submitted content items.

18. The responder application of claim 16 wherein the application pops up solicit content.

19. The responder application of claim 16 wherein the application tracks publication of submitted content items.

20. The responder application of claim 16 wherein the application sends censored content item to a central database collecting censored content.

21. The responder application of claim 16 wherein the application sending censored content items to an alternative site.
